(19) United States
(12) Patent Application Publication
(10) Pub. No.: US 2026/0269216 A1
(43) Pub. Date: Sep. 10, 2026

(54) BIPOLAR POLYMER CONDUCTOR ANODE FOR ALL-SOLID-STATE BATTERY

(71) Applicant: Schaeffler Technologies AG & Co. KG, Herzogenaurach (DE)

(72) Inventors: Kewei Liu, Wadsworth, OH (US); Rashid Farahati, Copley, OH (US)

(21) Appl. No.: 19/069,900

(22) Filed: Mar. 4, 2025

(51) Int. Cl. H01M 4/134; H01M 4/02; H01M 4/04; H01M 4/1395; H01M 4/66; H01M 10/052; H01M 10/0585

(52) U.S. Cl. CPC H01M 4/134; H01M 4/0404; H01M 4/1395; H01M 4/668; H01M 10/052; H01M 10/0585; H01M 2004/021; H01M 2004/029

(57) ABSTRACT

A bipolar polymer current collector may include a polymer substrate. A bipolar polymer current collector may include an anode metal conductor on a first surface of the polymer substrate. A bipolar polymer current collector may include a cathode metal conductor on a second surface of the polymer substrate opposite the first surface, wherein the anode metal conductor and the cathode metal conductor are in electrical contact.

### TECHNICAL FIELD

The present disclosure relates generally to solid-state batteries and, more particularly, to solid-state lithium batteries with a bipolar polymer collector anode.

### BACKGROUND

Bipolar plates serve as current collectors, facilitating the flow of electrons between adjacent cells in a battery stack. They physically separate the individual cells within the battery stack, preventing short circuits. They further provide mechanical support to the battery stack, maintaining the integrity of the cell assembly.

However, bipolar plates must be resistant to corrosion in the battery environment, which can be particularly challenging given the reactive nature of lithium metal. In existing designs, interfaces between bipolar plates and active materials may be unstable, which may lead to corrosion and degradation. There is therefore a need to develop systems and methods addressing the above deficiencies.

### SUMMARY

In embodiments, the techniques described herein relate to a bipolar polymer current collector including a polymer substrate; an anode metal conductor on a first surface of the polymer substrate; and a cathode metal conductor on a second surface of the polymer substrate opposite the first surface, where the anode metal conductor and the cathode metal conductor are in electrical contact.

In embodiments, the techniques described herein relate to a bipolar polymer current collector, where the polymer substrate includes at least one of SBR, PS, polyester, PET, or polycarbonate.

In embodiments, the techniques described herein relate to a bipolar polymer current collector, where the polymer substrate has a thickness in a range of 1 nanometer to 100 micrometers.

In embodiments, the techniques described herein relate to a bipolar polymer current collector, where the polymer substrate has a Young's modulus in a range of 10 MPa to 150 MPa.

In embodiments, the techniques described herein relate to a bipolar polymer current collector, where the polymer substrate has an elongation at break in a range of 0.01% to 500%.

In embodiments, the techniques described herein relate to a bipolar polymer current collector, where the anode metal conductor includes at least one of aluminum, stainless steel, or nickel.

In embodiments, the techniques described herein relate to a bipolar polymer current collector, where the cathode metal conductor includes at least one of copper, stainless steel, or nickel.

In embodiments, the techniques described herein relate to a bipolar polymer current collector, where the anode metal conductor has a thickness in a range of 1 nanometer to 10 micrometers.

In embodiments, the techniques described herein relate to a bipolar polymer current collector, where the cathode metal conductor has a thickness in a range of 1 nanometer to 10 micrometers.

In embodiments, the techniques described herein relate to a bipolar polymer current collector, where at least one of the anode metal conductor or the cathode metal conductor extend along at least one side of the polymer substrate to provide the electrical contact.

In embodiments, the techniques described herein relate to a bipolar polymer current collector, further including an additional conductor along one or more sides of the polymer substrate to provide the electrical contact.

In embodiments, the techniques described herein relate to a bipolar polymer current collector, where the polymer substrate includes conductive additives, where the electrical contact is provided through the polymer substrate.

In embodiments, the techniques described herein relate to a solid-state battery including two or more cells in a bipolar stack configuration with one or more bipolar polymer current collectors between the two or more cells, where a particular one of the bipolar polymer current collectors includes a polymer substrate; an anode metal conductor on a first surface of the polymer substrate; and a cathode metal conductor on a second surface of the polymer substrate opposite the first surface, where the anode metal conductor and the cathode metal conductor are in electrical contact.

In embodiments, the techniques described herein relate to a solid-state battery, where the polymer substrate includes at least one of SBR, PS, polyester, PET, or polycarbonate.

In embodiments, the techniques described herein relate to a solid-state battery, where the polymer substrate has a thickness in a range of 1 nanometer to 100 micrometers.

In embodiments, the techniques described herein relate to a solid-state battery, where the polymer substrate has a Young's modulus in a range of 10 MPa to 150 MPa.

In embodiments, the techniques described herein relate to a solid-state battery, where the polymer substrate has an elongation at break in a range of 0.01% to 500%.

In embodiments, the techniques described herein relate to a method for fabricating a bipolar polymer current collector including depositing an anode metal conductor on a first surface of a polymer substrate; and depositing a cathode metal conductor on a second surface of the polymer substrate opposite the first surface, where the anode metal conductor and the cathode metal conductor are in electrical contact.

In embodiments, the techniques described herein relate to a method for fabricating the bipolar polymer current collector, where depositing the anode metal conductor on the first surface of the polymer substrate includes depositing the anode metal conductor on the first surface of the polymer substrate with at least one of a physical vapor deposition process, a spray coating process, an electroplating process, or an electroless plating process; where depositing the cathode metal conductor on the second surface of the polymer substrate includes depositing the cathode metal conductor on the second surface of the polymer substrate with at least one of a physical vapor deposition process, a spray coating process, an electroplating process, or an electroless plating process.

In embodiments, the techniques described herein relate to a method for fabricating the bipolar polymer current collector, where depositing the anode metal conductor on the first surface of the polymer substrate includes depositing the anode metal conductor on the first surface of the polymer substrate with a thickness in a range of 1 nanometer to 10 micrometers; where depositing the cathode metal conductor on the second surface of the polymer substrate includes depositing the cathode metal conductor on the second surface of the polymer substrate with a thickness in a range of 1 nanometer to 10 micrometers.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a block diagram of an all-solid-state battery (ASSB), in accordance with one or more embodiments of the present disclosure.

FIG. 1B illustrates a block diagram view of an ASSB that depicts anode and cathode materials interfacing with bipolar polymer current collectors, in accordance with one or more embodiments of the present disclosure.

FIG. 2A illustrates a simplified side view of one nonlimiting design of a bipolar polymer current collector, in accordance with one or more embodiments of the present disclosure.

FIG. 2B illustrates a simplified side view of a second design of a bipolar polymer current collector, in accordance with one or more embodiments of the present disclosure.

FIG. 2C illustrates a simplified side view of one nonlimiting design of a bipolar polymer current collector, in accordance with one or more embodiments of the present disclosure.

FIG. 2D illustrates a simplified side view of one nonlimiting design of a bipolar polymer current collector, in accordance with one or more embodiments of the present disclosure.

FIG. 2E illustrates a simplified side view of one nonlimiting design of a bipolar polymer current collector, in accordance with one or more embodiments of the present disclosure.

FIG. 3 is a flow diagram illustrating steps performed in a method for fabricating a bipolar polymer current collector, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an all-solid-state battery (ASSB) including a bipolar polymer current collector formed as a polymer substrate with metal layers on opposing sides (e.g., surfaces) of the polymer substrate. In this configuration, one side of the bipolar polymer current collector may operate as an anode, while the other side may operate as a cathode. Further, an ASSB may be generated with bipolar stack of cells with bipolar polymer current collectors separated by solid state electrolyte material.

A manufactured ASSB is typically constructed from rigid components (e.g., anode, cathode, solid electrolyte, or the like) that are held in contact (e.g., with some pressure). In this design, various conditions may give rise to a potential non-uniform pressure distribution across the current collectors such as, but not limited to, roughness of a solid electrolyte or non-uniform thicknesses of various cell components. However, such non-uniform pressure distribution may negatively impact the performance of the ASSB. For example, providing a stable interface between a current collector and the solid electrolyte is crucial to prevent degradation and maintain performance. In particular, it may be desirable to provide uniform electrical conductivity across interfaces between current collectors and solid-state electrolytes to ensure even current distribution, stable performance, and avoid degradation.

It is contemplated that polymer substrate of a bipolar polymer current collector as disclosed herein may facilitate uniform pressure and uniform electrical contact with active solid electrolyte material.

Some embodiments of the present disclosure are directed to a bipolar polymer current collector suitable for use in an ASSB or a cell thereof. Some embodiments of the present disclosure are directed to an ASSB battery cell including a bipolar polymer current collector. Some embodiments of the present disclosure are directed to an ASSB including one or more cells with bipolar polymer current collectors. Some embodiments of the present disclosure are directed to a method of fabricating a bipolar polymer current collector suitable for use in an ASSB or a cell thereof.

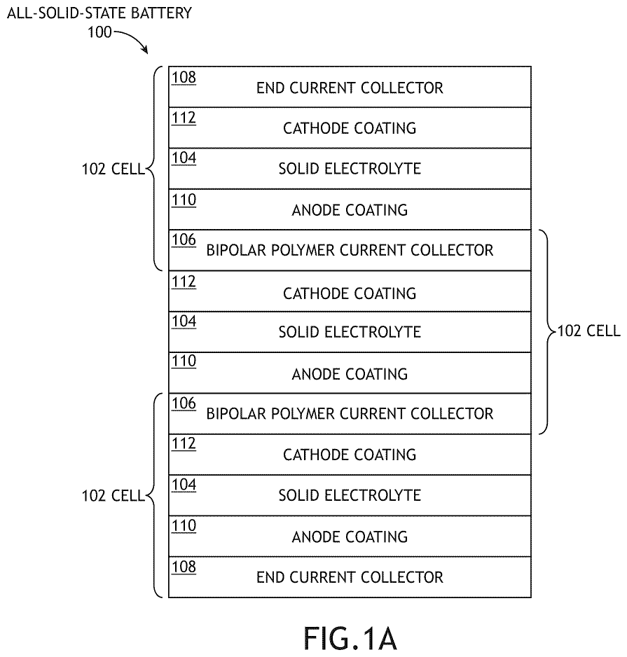

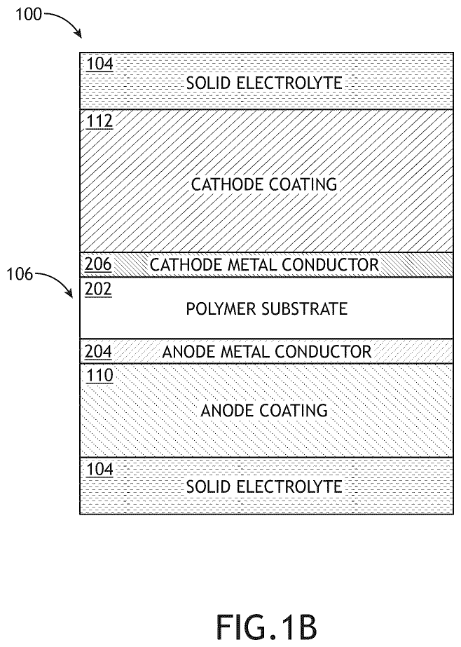

Referring now to FIGS. 1A-3, systems and methods providing a layered anode suitable for an ASSB, in accordance with one or more embodiments of the present disclosure.

FIG. 1A illustrates a block diagram of an ASSB 100, in accordance with one or more embodiments of the present disclosure.

In embodiments, the ASSB 100 includes one or more cells 102, where a cell 102 includes a solid electrolyte 104 between two current collectors, where at least one of the current collectors is a bipolar polymer current collector 106. For example, FIG. 1A depicts an ASSB 100 with three cells 102, where bipolar polymer current collectors 106 are located between cells 102. The ASSB 100 further includes additional components that form the various cells 102 including end current collectors 108 on the top and bottom ends of the stack of cells 102, an anode coating 110 between the solid electrolyte 104 and one side of the bipolar polymer current collector 106, and a cathode coating 112 between the solid electrolyte 104 and another side of the cathode metal conductor 206.

In this configuration, a bipolar polymer current collector 106 may interface with the anode coating 110 for one cell 102 and the cathode coating 112 for another cell 102 in a bipolar stack configuration.

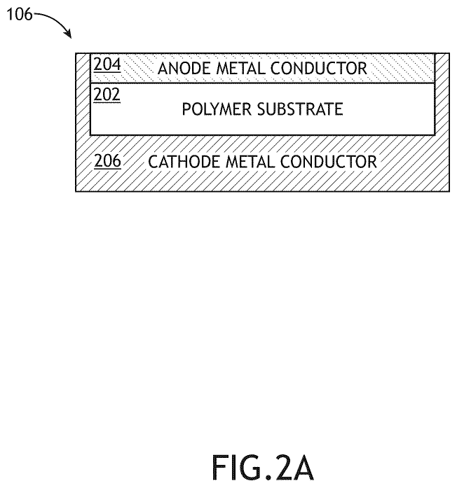

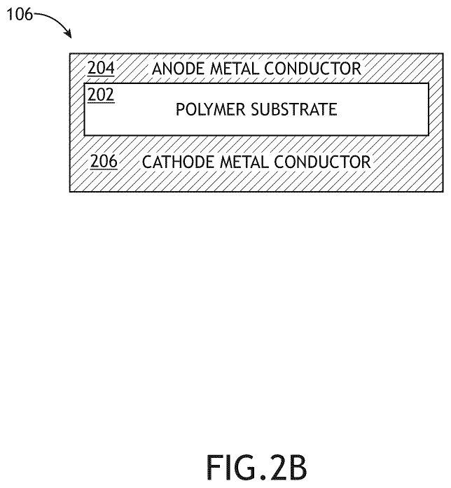

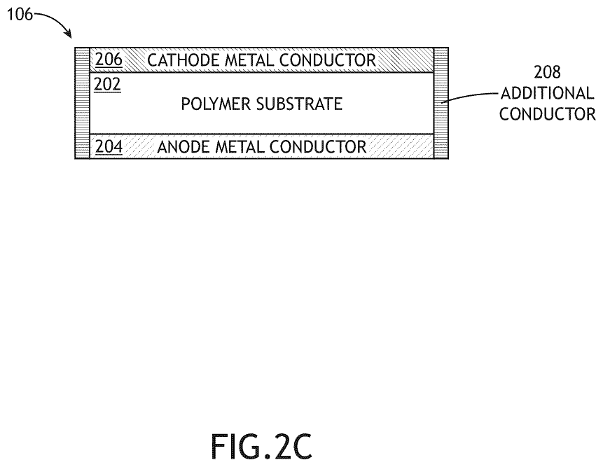

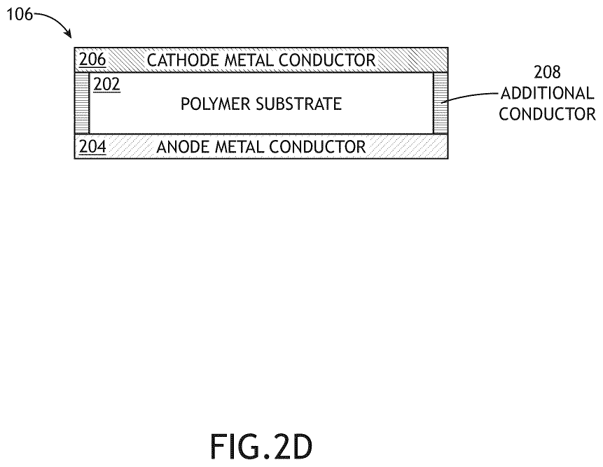

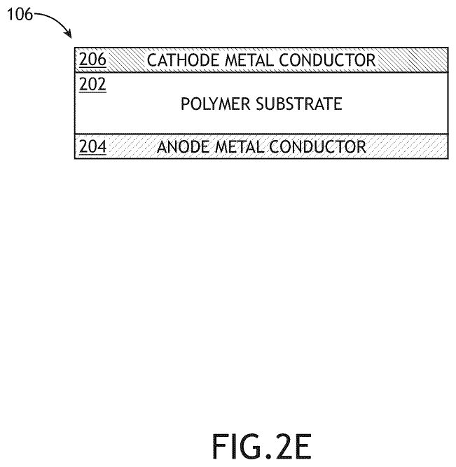

FIG. 2A illustrates a simplified side view of one nonlimiting design of a bipolar polymer current collector 106, in accordance with one or more embodiments of the present disclosure.

In embodiments, a bipolar polymer current collector 106 includes a polymer substrate 202 with an anode metal conductor 204 on one side (e.g., a first side) of the polymer substrate 202 and a cathode metal conductor 206 on an opposing side (e.g., a second side) of the polymer substrate 202. In this way, the anode metal conductor 204 may operate as an anode current collector in one cell 102 and the cathode metal conductor 206 may operate as a cathode current collector in an adjacent cell 102.

The anode metal conductor 204 may include any composition suitable for interfacing with an anode in an ASSB 100 such as, but not limited to, aluminum, stainless steel, or nickel. The cathode metal conductor 206 may include any composition suitable for interfacing with a cathode in an ASSB 100 such as, but not limited to, copper, stainless steel, or nickel. The anode metal conductor 204 and the cathode metal conductor 206 may have any suitable thicknesses. For example, the anode metal conductor 204 and/or the cathode metal conductor 206 may have thicknesses in the range of 1 nanometer to 10 micrometers.

In some embodiments, the anode metal conductor 204 and the cathode metal conductor 206 may be formed from a common composition suitable for use as both an anode current collector and a cathode current collector such as, but not limited to, nickel, stainless steel, or any suitable metal alloy. FIG. 2B illustrates a simplified side view of a second design of a bipolar polymer current collector 106 including an anode metal conductor 204 and a cathode metal conductor 206 formed from a common material, in accordance with one or more embodiments of the present disclosure.

The polymer substrate 202 may include any composition suitable for uniformizing a pressure distribution and thus uniform electrical contact between solid electrolytes 104 on opposing sides of the bipolar polymer current collector 106. It is contemplated herein that the polymer substrate 202 need not create a perfectly uniform pressure distribution. In some applications, the polymer substrate 202 facilitates a pressure distribution across the bipolar polymer current collector 106 that is uniform within a selected tolerance. Any selected tolerance may be chosen based on the application. For example, the tolerance may be a pressure variation (e.g., an average pressure variation, a maximum pressure variation, or the like) at or below a selected percentage (e.g., 0.1%, 1%, 5%, 10%, or any selected value).

It is further contemplated herein that the ability of a polymer substrate 202 to uniformize a pressure distribution may depend on mechanical properties related to rigidity. In a general sense, reducing the rigidity of the polymer substrate 202 may improve the performance so long as the polymer substrate 202 is sufficiently rigid to remain in place. In some embodiments, the polymer substrate 202 has a Young's Modulus in a range of 10 MPa to 150 GPa. In some embodiments, the polymer substrate 202 has an elongation at break value in a range of 0.01% to 500%. For example, the elongation at break value may characterize a percentage increase in length the polymer substrate 202 can withstand before breaking. Non-limiting examples of the polymer substrate 202 include styrene-butadiene rubber (SBR), polystyrene (PS), polyester, polycarbonate, or polyethylene terephthalate (PET).

The polymer substrate 202 may further have any thickness suitable for providing a desired pressure distribution and mechanical integrity. For example, the polymer substrate 202 may have a thickness in a range of 1 nanometer to 100 micrometers.

In some embodiments, as described in greater detail below, the polymer substrate 202 includes conductive additives such that the polymer substrate 202 may be electrically conductive. In this way, the polymer substrate 202 may be characterized as a composite polymer. The polymer substrate 202 may include any type of conductive additive including, but not limited to, metal particles or carbon compounds (e.g., carbonaceous materials). For example, the polymer substrate 202 may include conductive additives such as, but not limited to, graphite, graphene, carbon nanotubes, diamond carbon, metal fiber, or metal mesh. Further, the polymer substrate 202 may include any concentration of conductive additives to provide that the polymer substrate 202 has any selected electrical conductivity value. In some embodiments, the polymer substrate 202 has a conductivity in a range of 1×10² S/m to 7×10⁷ S/m, though this is not a requirement.

Referring now generally to FIGS. 2A-2E, the anode metal conductor 204 and the cathode metal conductor 206 may be in electrical contact. In this way, the bipolar polymer current collector 106 may facilitate the transfer of electrons between cells. The anode metal conductor 204 and the cathode metal conductor 206 may be electrically connected using any technique.

In some embodiments, the anode metal conductor 204 and the cathode metal conductor 206 are in direct contact at one or more contact points. For example, the anode metal conductor 204 and/or the cathode metal conductor 206 may be deposited along sides of the polymer substrate 202 to provide the electrical contact. As an illustration, FIG. 2A depicts a non-limiting configuration in which the cathode metal conductor 206 extends along sides of the polymer substrate 202 to contact the anode metal conductor 204. As another illustration, though not shown, the anode metal conductor 204 may extend along sides of the polymer substrate 202 to contact the cathode metal conductor 206.

FIG. 2B illustrates a simplified side view of one nonlimiting design of a bipolar polymer current collector 106, in accordance with one or more embodiments of the present disclosure. In FIG. 2B, the anode metal conductor 204 and the cathode metal conductor 206 are formed from the same material, where this material extends down sides of the polymer substrate 202.

In some embodiments, the cell 102 includes an additional conductor 208 deposited along edges of the polymer substrate 202 to provide electrical contact between the anode metal conductor 204 and the cathode metal conductor 206. The additional conductor 208 may include any conductor known in the art such as, but not limited to, aluminum, copper, nickel, stainless steel, any metal alloy, or any metal.

FIG. 2C illustrates a simplified side view of one nonlimiting design of a bipolar polymer current collector 106, in accordance with one or more embodiments of the present disclosure. In FIG. 2C, the additional conductor 208 is shown as extending along sides of anode metal conductor 204, the polymer substrate 202, and the cathode metal conductor 206.

FIG. 2D illustrates a simplified side view of one nonlimiting design of a bipolar polymer current collector 106, in accordance with one or more embodiments of the present disclosure. In FIG. 2D, the additional conductor 208 is shown along the sides of the polymer substrate 202, where the anode metal conductor 204 and the cathode metal conductor 206 are deposited on the polymer substrate 202 as well as the additional conductor 208 surrounding the polymer substrate 202.

FIG. 2E illustrates a simplified side view of one nonlimiting design of a bipolar polymer current collector 106, in accordance with one or more embodiments of the present disclosure. In FIG. 2E, the polymer substrate 202 includes a composite polymer material with conductive additives such that the anode metal conductor 204 and the cathode metal conductor 206 may be in electrical contact through the polymer substrate 202. In this configuration, the anode metal conductor 204 and the cathode metal conductor 206 do not need to be in direct contact (e.g., as depicted in FIGS. 2A-2B) or connected by an additional conductor 208 (e.g., as depicted in FIGS. 2C-2D).

Referring again to FIGS. 1A-1B, the integration of a bipolar polymer current collector into an ASSB 100 is described in greater detail.

FIG. 1B illustrates a block diagram view of the ASSB 100 that depicts anode and cathode materials interfacing with bipolar polymer current collectors 106, in accordance with one or more embodiments of the present disclosure. In particular, FIG. 1B depicts a cell 102 in the nonlimiting configuration of FIG. 2D, where an anode coating 110 is placed between the anode metal conductor 204 and the solid electrolyte 104 of one cell 102, and where a cathode coating 112 is placed between the cathode metal conductor 206 and the solid electrolyte 104 of another cell 102. For example, the cells 102 may be stacked as shown in FIG. 1A.

An ASSB 100 may include any type or composition of anode coating 110 suitable for operation as an anode. For example, the anode coating 110 may include, but is not limited to, metallic lithium, a carbon compound (e.g., graphite, graphene, carbon nanotubes, metal fiber, metal mesh, or the like), semiconductor materials (e.g., silicon, or the like), or metal alloy (e.g., aluminum, tin, magnesium, silver, or the like).

An ASSB 100 may include any type or composition of cathode coating 112 suitable for operation as a cathode. For example, the cathode coating 112 may include lithium-ion manganese oxide (LMO), where the active material may include manganese oxide in any suitable form including, but not limited to Li₂Mn₂O₄, LiMnO₂, Li₂MnO₂, or a composite thereof. As another example, the cathode coating 112 may include lithium iron phosphate (LFP) such as, but not limited to, LiFePO₄. As another example, the cathode coating 112 may include lithium nickel manganese cobalt oxide (Li-NMC). As another example, the cathode coating 112 may include sulfur or lithium sulfide.

Further, although FIG. 1B depicts both an anode coating 110 and a cathode coating 112, this is not a requirement. In some embodiments, the ASSB 100 has an anode-free design or a lithium-free anode design such that lithium is deposited on the anode metal conductor 204 during cycling. In this configuration, the anode coating 110 may not be present.

An ASSB 100 may include any type or composition of solid electrolyte 104 suitable for operation as a solid-state battery. In this way, a bipolar polymer current collector 106 may be utilized in any desired chemistry of an ASSB 100.

The solid electrolyte 104 may have any composition known in the art including, but not limited to, oxide electrolytes, sulfide electrolytes, polymer electrolytes, halide electrolytes, composite electrolytes, or hybrid solid-liquid electrolytes. For example, the solid electrolyte 104 may include lithium phosphorus oxynitride (LiPON). As another example, the solid electrolyte 104 may include sodium super-ionic conductors (NASICON) such as, but not limited to, LTP, LATP, or LAGP). As another example, the solid electrolyte 104 may include lithium super-ionic conductors (LISICON) such as, but not limited to, LGPS, LiPS, or LiSiPS. As another example, the solid electrolyte 104 may include garnets such as, but not limited to, LLZO. Various other non-limiting examples include LiBH₄, LYC, LYB, Li₃N, or LLTO.

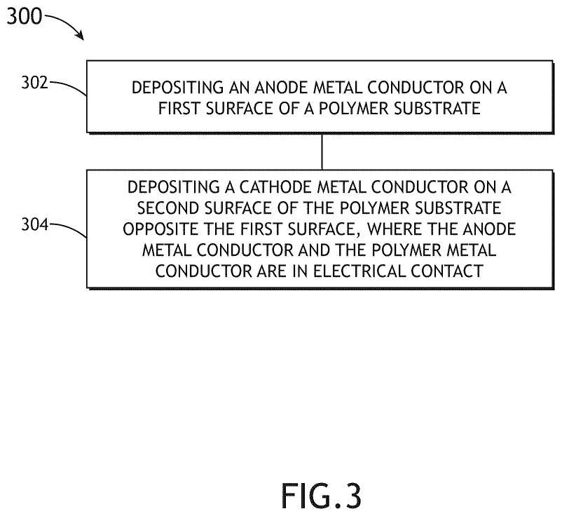

Referring now to FIG. 3, FIG. 3 is a flow diagram illustrating steps performed in a method 300 for fabricating a bipolar polymer current collector 106, in accordance with one or more embodiments of the present disclosure. The embodiments and enabling technologies described previously herein in the context of the ASSB 100 should be interpreted to extend to method 300. It is further noted, however, that the method 300 is not limited to the architecture of ASSB 100.

The method 300 may include a step 302 of depositing an anode metal conductor 204 on a first surface of a polymer substrate 202. The method 300 may include a step 304 of depositing a cathode metal conductor 206 on a second surface of the polymer substrate 202 opposite the first surface, where the anode metal conductor 204 and the cathode metal conductor 206 are in electrical contact.

As described with respect to FIGS. 1A-2E, the polymer substrate 202 may be formed from any composition and with any thickness suitable for uniformizing contact between a solid electrolyte 104 with the anode metal conductor 204 and/or the cathode metal conductor 206 within a selected tolerance. For example, the tolerance may be a pressure variation (e.g., an average pressure variation, a maximum pressure variation, or the like) at or below a selected percentage (e.g., 0.1%, 1%, 5%, 10%, or any selected value). In this way, the bipolar polymer current collector may promote even current distribution, stable performance, and avoid degradation.

Similarly, the anode metal conductor 204 and the cathode metal conductor 206 may have any compositions or thicknesses suitable foFFFFr operation in an ASSB 100 with any desired chemistry.

Further, the deposition steps (e.g., step 302 and step 304) may be performed using any deposition technique including, but not limited to, a physical vapor deposition process, a spray coating process, an electroplating process, or an electroless plating process.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

### LIST OF REFERENCE NUMBERS

100 all-solid-state battery (ASSB)
102 cell
104 solid electrolyte
106 bipolar polymer current collector
108 end current collectors
110 anode coating
112 cathode coating
202 polymer substrate
204 anode metal conductor
206 cathode metal conductor
208 additional conductor
300 method
302 step
304 step

What is claimed:

1. A bipolar polymer current collector comprising:
a polymer substrate;
an anode metal conductor on a first surface of the polymer substrate; and
a cathode metal conductor on a second surface of the polymer substrate opposite the first surface, wherein the anode metal conductor and the cathode metal conductor are in electrical contact.

2. The bipolar polymer current collector of claim 1, wherein the polymer substrate comprises:
at least one of SBR, PS, polyester, PET, or polycarbonate.

3. The bipolar polymer current collector of claim 1, wherein the polymer substrate has a thickness in a range of 1 nanometer to 100 micrometers.

4. The bipolar polymer current collector of claim 1, wherein the polymer substrate has a Young's modulus in a range of 10 MPa to 150 MPa.

5. The bipolar polymer current collector of claim 1, wherein the polymer substrate has an elongation at break in a range of 0.01% to 500%.

6. The bipolar polymer current collector of claim 1, wherein the anode metal conductor comprises:
at least one of aluminum, stainless steel, or nickel.

7. The bipolar polymer current collector of claim 1, wherein the cathode metal conductor comprises:
at least one of copper, stainless steel, or nickel.

8. The bipolar polymer current collector of claim 1, wherein the anode metal conductor has a thickness in a range of 1 nanometer to 10 micrometers.

9. The bipolar polymer current collector of claim 1, wherein the cathode metal conductor has a thickness in a range of 1 nanometer to 10 micrometers.

10. The bipolar polymer current collector of claim 1, wherein at least one of the anode metal conductor or the cathode metal conductor extend along at least one side of the polymer substrate to provide the electrical contact.

11. The bipolar polymer current collector of claim 1, further comprising:
an additional conductor along one or more sides of the polymer substrate to provide the electrical contact.

12. The bipolar polymer current collector of claim 1, wherein the polymer substrate comprises conductive additives, wherein the electrical contact is provided through the polymer substrate.

13. A solid-state battery comprising:
two or more cells in a bipolar stack configuration with one or more bipolar polymer current collectors between the two or more cells, wherein a particular one of the one or more bipolar polymer current collectors comprises:
a polymer substrate;
an anode metal conductor on a first surface of the polymer substrate; and
a cathode metal conductor on a second surface of the polymer substrate opposite the first surface, wherein the anode metal conductor and the cathode metal conductor are in electrical contact.

14. The solid-state battery of claim 13, wherein the polymer substrate comprises:
at least one of SBR, PS, polyester, PET, or polycarbonate.

15. The solid-state battery of claim 13, wherein the polymer substrate has a thickness in a range of 1 nanometer to 100 micrometers.

16. The solid-state battery of claim 13, wherein the polymer substrate has a Young's modulus in a range of 10 MPa to 150 MPa.

17. The solid-state battery of claim 13, wherein the polymer substrate has an elongation at break in a range of 0.01% to 500%.

18. A method for fabricating a bipolar polymer current collector comprising:
depositing an anode metal conductor on a first surface of a polymer substrate; and
depositing a cathode metal conductor on a second surface of the polymer substrate opposite the first surface, where the anode metal conductor and the cathode metal conductor are in electrical contact.

19. The method for fabricating the bipolar polymer current collector of claim 18, wherein depositing the anode metal conductor on the first surface of the polymer substrate comprises depositing the anode metal conductor on the first surface of the polymer substrate with at least one of a physical vapor deposition process, a spray coating process, an electroplating process, or an electroless plating process; wherein depositing the cathode metal conductor on the second surface of the polymer substrate comprises depositing the cathode metal conductor on the second surface of the polymer substrate with at least one of a physical vapor deposition process, a spray coating process, an electroplating process, or an electroless plating process.

20. The method for fabricating the bipolar polymer current collector of claim 18, wherein depositing the anode metal conductor on the first surface of the polymer substrate comprises depositing the anode metal conductor on the first surface of the polymer substrate with a thickness in a range of 1 nanometer to 10 micrometers; wherein depositing the cathode metal conductor on the second surface of the polymer substrate comprises depositing the cathode metal conductor on the second surface of the polymer substrate with a thickness in a range of 1 nanometer to 10 micrometers.
